(19) United States
(12) Patent Application Publication
(10) Pub. No.: US 2014/0224668 A1
(43) Pub. Date: Aug. 14, 2014

(54) METHOD FOR OPERATING AN ELECTROLYTIC CELL

(71) Applicant: Astrium GmbH, Taufkirchen (DE)

(72) Inventors: Walter JEHLE, Horgenzell (DE); Joachim LUCAS, Herdwangen-Schoenach (DE); Willigert RAATSCHEN, Immenstaad (DE)

(73) Assignee: Astrium GmbH, Taufkirchen (DE)

(21) Appl. No.: 14/161,899

(22) Filed: Jan. 23, 2014

(30) Foreign Application Priority Data
Feb. 12, 2013 (EP) 13154908.1

(51) Int. Cl. C25B 13/02; C25B 9/08; B23C 3/00; C25B 1/10

(52) U.S. Cl. CPC C25B 13/02; C25B 1/10; C25B 9/08; B23C 3/00
USPC 205/628; 204/263; 83/13

(57) ABSTRACT

A method for operating an electrolytic cell for electrolytic water splitting in which at least one membrane is supplied with water in a passive manner.

### BACKGROUND OF THE INVENTION

The invention relates to a method for operating an electrolytic cell for electrolytic water splitting having at least one membrane according to the preamble of claim 1.

Electrolytic cells for electrolytic splitting of water into hydrogen and oxygen according to the prior art comprise two electrodes separated by an electrolyte-filled membrane, a charge exchange taking place via the electrolyte-filled membrane so as to enable electrolytic splitting. In this case, the water is split in a contact zone between the membrane and the electrodes. In addition to feeding water, which is to be split electrolytically, to the contact zone of the membrane, it is also necessary to ensure moistening of the membrane, so as to avoid damage due to desiccation. In methods for operating an electrolytic cell according to the prior art it has therefore always been necessary either to introduce a large quantity of water into the electrolytic cell, for example by flooding gas chambers for hydrogen and oxygen with water and/or electrolyte, or to use a delivery device, comprising a pump for example, for targeted delivery of water directly onto or into the membrane. Operation of the delivery device, for example the pump, requires additional apparatus and additional energy input. In published European patent application EP 2 463 407 A1 belonging to the applicant, such a method for operating an electrolytic cell is described, in which water is pumped into microchannels in a membrane for further distribution in the membrane. In the process, it has been surprisingly found that it is possible, using the membrane proposed therein, to achieve a passive water supply system, which makes it possible to dispense with a delivery device.

The objective of the invention consists in particular in providing a method for operating an electrolytic cell with reduced apparatus requirements and reduced energy consumption. The objective is achieved according to the invention by the features of claim 1, while advantageous configurations and further developments of the invention can be inferred from the subclaims.

In addition, an electrolytic system is proposed, which has at least one electrolytic cell for electrolytic water splitting, the electrolytic cell comprising at least one membrane, and which has a water feed unit for supplying water to the electrolytic cell, the at least one membrane being implemented as a passive water supply unit.

### ADVANTAGES OF THE INVENTION

The invention is based on a method for operating an electrolytic cell for electrolytic water splitting having at least one membrane. It is proposed that the at least one membrane is supplied with liquid water in a passive manner.

The membrane is formed in particular of a diaphragm, which allows transfer only of specific ions, for example of hydroxide ions or protons, but does not permit passage of atomic or molecular hydrogen and oxygen, and which is filled with an electrolyte, for example a potassium hydroxide solution or another electrolyte, or is formed of a cation exchange membrane, an anion exchange membrane or a proton exchange membrane, via which only cations, anions or individual protons can be exchanged. The membrane is preferably made from a polymer, in particular a polysulfone or a polyphenylene sulfide. “Supply with liquid water in a passive manner” should be understood in particular to mean that the membrane is supplied, without a pump, with liquid water from a water reservoir, which adjoins the membrane or is connected to the membrane, and the membrane is implemented specifically for the purpose of delivering water from the water reservoir into an inner region of the membrane and distributing it within the inner region by means of physical forces of a membrane material, in particular adhesion forces of the inner and outer surfaces of the membrane material, and an intake capacity and distribution capacity of the membrane are specifically designed to replenish water consumed by electrolysis at a maximum capacity in a safe operating state. Passive supply of the membrane with liquid water is in particular different from water supply to the membrane in which water is introduced into the membrane in the form of vapor and condensed therein. A “water reservoir” should be understood in particular to mean a water volume, in particular a water volume accommodated in a water tank and/or a water pipe, which is provided for supplying the membrane. “Specifically designed” should be understood in particular to mean specifically configured, specifically treated and/or made from specific materials. Reduced energy consumption may in particular be achieved.

In a further development of the method according to the invention, it is proposed that in at least one method step water is distributed within the membrane by means of at least one channel structure formed in the at least one membrane. “A channel structure” should be understood in particular to mean a structure with elongate cavities, which have a length which is at least ten times, advantageously at least fifty times and preferably at least a hundred times the diameter of the cavity. In particular, a channel structure is different from a structure with cavities formed as pores, in which a plurality of pores merge directly together. In particular, the channel structure is formed in a inner membrane region and has no openings into at least one surface of the membrane, which forms a contact surface for contact with electrodes. A “inner membrane region” should in particular be understood to mean a sub-region of the membrane which is surrounded on at least two sides by at least one outer membrane region which differs from the inner membrane region at least in the material from which it is made and/or in at least one material value, for example porosity or elasticity. The inner membrane region is in particular free of any contact region with electrodes and separated from the electrodes by the at least one outer membrane region. The inner membrane region in which the channel structure is arranged in particular comprises a structure which is coarse-pored relative to the outer membrane region which is free of the channel structure, coarse-pored being understood to mean that the average pore diameter in the inner membrane region is at least ten percent, advantageously at least twenty percent and preferably at least fifty percent greater than the average pore diameter in the outer membrane region. In particular, the channel structure has a high transfer capacity over longer distances compared with the pores of the outer membrane region. In particular, a high water distribution capacity within the membrane may be achieved.

It is moreover proposed that in at least one method step water is introduced, without a pump, from a water reservoir into the membrane by means of a capillary effect of at least one cavity structure of the at least one membrane. A “cavity structure” should be understood in particular to mean a structure with a plurality of cavities, preferably pores, distributed in the material. A “capillary effect” should be understood in particular to mean an effect in which a liquid, in particular water, is drawn into a cavity structure and spreads therein by surface tension and interfacial effects in the cavity structure, in particular also against the effect of gravity. A strength of the capillary effect may be achieved in particular by an indication of a capillary pressure and/or a capillary rise. “Capillary rise” should be understood in particular to mean a maximum height of a liquid column, in particular a water column, which is established, owing to the capillary effect, in the cavity structure against the effect of gravity. In particular, the at least one cavity structure is formed at least in a outer membrane region which is free of a channel structure. In particular, water passes by the capillary effect of the cavity structure out of the water reservoir into the channel structure, in which the water is then further distributed in the membrane. “Introduced, without a pump, from a water reservoir into the membrane” should be understood in particular to mean that the uptake of water into the membrane from the water reservoir is achieved by the capillary effect of the at least one cavity structure without any assistance from pressure and/or suction produced by a pump. A “water reservoir” should be understood in particular to mean a space filled with liquid water and/or a pipe filled with liquid water, which provides water for uptake by the membrane, wherein the space filled with water and/or the pipe filled with water may be connected to a device for water replenishment. It is possible to achieve passive water uptake by the membrane in particular in a structurally simple manner and to reduce the apparatus and energy input required for water supply of the membrane.

It is moreover proposed for water to be introduced into the membrane in the at least one method step with a capillary pressure of at least 25 mbar, advantageously of at least 50 mbar, preferably of at least 100 mbar and particularly preferably of at least 200 mbar. A capillary rise in the membrane achieved by the capillary pressure amounts in particular to at least 0.25 meters, advantageously at least 0.5 meters, preferably 1 meter and particularly preferably at least 2 meters. A high uptake capacity may in particular be achieved for the membrane.

In addition, an electrolytic system is proposed with at least one electrolytic cell for electrolytic water splitting, the electrolytic cell comprising at least one membrane, and with a water feed unit for supplying water to the electrolytic cell, the at least one membrane being implemented as a passive water supply unit. A “water feed unit” should be understood in particular to mean a unit having at least one water storage space, in particular a water tank, in which liquid water is stored, and at least one water pipe, which preferably is implemented as a water channel and connects the water tank to the at least one membrane. The water pipe is provided to convey liquid water up to the membrane. In particular, a water reservoir for supplying the at least one membrane with water is arranged in the water feed unit and supported there. A “water supply unit” should be understood in particular to mean a unit which is provided to introduce water from the water feed unit into the membrane and to distribute it in the membrane. In particular, the water supply unit comprises at least one cavity structure of the membrane, in which the water is guided. Water supply units according to the prior art comprise at least one pump for introducing water into the membrane. A “passive water supply unit” should be understood in particular to mean a water supply unit which does not have any elements which require an external power supply to achieve water supply of the membrane, such as for example a pump or a heating element for vaporizing water. It is in particular possible to achieve an electrolytic system with a reduced energy requirement and reduced apparatus.

It is moreover proposed that the passive water supply unit comprise at least one channel structure for large-area distribution of water within the at least one membrane. In particular, a high water distribution capacity within the membrane may be achieved.

It is moreover proposed that the passive water supply unit comprise at least one cavity structure for taking up water by capillary effect. In particular, a membrane may be achieved which has a high delivery capacity for liquids from a liquid reservoir adjoining the cavity structure.

It is additionally proposed that the at least one cavity structure have a pore size of at most 10 micrometers, advantageously of at most 5 micrometers and preferably of at most 2 micrometers. A “pore size of the cavity structure” should be understood in particular to mean an average pore size of the cavity structure, wherein in particular any deviation in pore size of the cavity structure amounts to at most twenty percent, advantageously at most ten percent and preferably at most five percent of the average pore size of the cavity structure. A “pore size” should be understood in particular to mean an average pore diameter. A membrane may in particular be achieved in which the capillary effect of the cavity structure has a high capillary rise and thus a high delivery capacity.

It is moreover proposed that the at least one membrane be connected to the water feed unit, without a pump. “Connected without a pump” should be understood in particular to mean that a water pipe and a water storage tank of the water feed unit do not have a pump which pumps water in and/or through the membrane, such that water is introduced into the water feed unit without a pump, and that water is drawn from the water feed unit by the membrane using the effect of a force from an element other than a pump, for example a force resulting from a capillary effect of a membrane. It is in particular possible to dispense with a pump, which requires additional energy input.

It is moreover proposed that the at least one membrane be bonded to a cell frame. “Bonded” should be understood in particular to mean fastened to one another by atomic or molecular interaction, for example by adhesion, welding and/or injection-molding. A “cell frame” should be understood in particular to mean cell walls of the electrolytic cell. In particular, the cell frame is made at least in part of a plastics material, in particular a temperature-resistant plastics material, which withstands a temperature of at least 70 degrees Celsius, advantageously at least 80 degrees Celsius and preferably at least 100 degrees Celsius. In principle, the cell frame may also be made at least in part from another material, for example metal or a ceramic material. Sealing of the electrolytic cell may in particular be achieved without the need for a separate sealing element.

Furthermore, an electrolytic cell is proposed for an electrolytic system according to the invention.

In addition, a method is proposed for producing a membrane of an electrolytic cell according to the invention, in which method a channel structure is milled mechanically into at least one first membrane sub-unit. “Milled into” should be understood in particular to mean produced by a milling machine from a material of the at least one membrane sub-unit. In principle, the channel structure may also be produced, instead of by milling, by another process, for example etching or cutting. The first membrane sub-unit is in particular intended to be used as the inner membrane region. In principle, the channel structure may also alternatively be produced by using a hollow fiber or tubes as a first membrane sub-unit. It is in particular possible to achieve simple, easily automated production of the channel structure.

It is moreover proposed that the at least one first membrane sub-unit be connected to at least one second membrane sub-unit which at least partially envelops the at least one first membrane sub-unit. “At least partially envelops” should be understood to mean in particular that the at least one second membrane sub-unit encloses the at least one first membrane sub-unit after connection on at least one side, advantageously on at least two sides. In particular, the first membrane sub-unit has a coarse-pored structure relative to the second membrane sub-unit. In particular, the at least one second membrane sub-unit comprises a cavity structure for producing a capillary effect for taking up water from a water reservoir. Particularly preferably, the at least one second membrane sub-unit has a cavity structure with a pore size of at most 10 micrometers, advantageously of at most 5 micrometers and preferably of at most 2 micrometers, which preferably produces a capillary effect with a capillary pressure of at least 40 mbar, advantageously of at least 50 mbar, preferably of at least 100 mbar and particularly preferably of at least 200 mbar. The at least one second membrane sub-unit is in particular free of any channel structure. Structurally simple production of the membrane may in particular be achieved.

### DRAWINGS

Further advantages are revealed by the following description of the drawings. The drawings show an exemplary embodiment of the invention. The drawings, description and the claims contain numerous features in combination. A person skilled in the art will expediently also consider the features individually and combine them into meaningful further combinations.

In the figures:

FIG. 1 shows an electrolytic system with an electrolytic cell for electrolytic water splitting, which is operated using the method according to the invention, and

FIG. 2 is a detail view of a membrane of an electrolytic system according to the invention.

### DESCRIPTION OF THE EXEMPLARY EMBODIMENTS

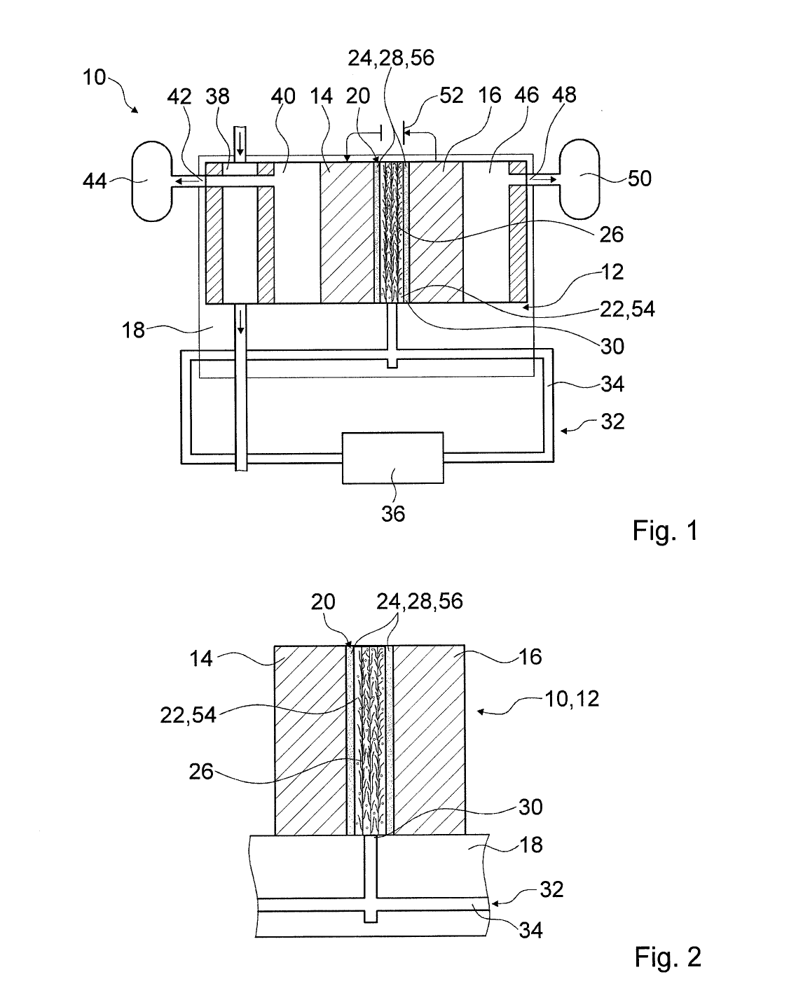

FIG. 1 shows an electrolytic system 10 having an electrolytic cell 12 for electrolytic water splitting, the electrolytic cell 12 comprising a membrane 20, and having a water feed unit 32 for feeding water to the electrolytic cell 12. The electrolytic cell 12 is configured to perform the method according to the invention for operating an electrolytic cell 12 for electrolytic water splitting having at least one membrane 20, in which the membrane 20 is supplied with water in a passive manner. The electrolytic cell 12 is implemented as an alkaline electrolytic cell 12, which comprises two porous electrodes 14, 16 of nickel with catalytic coatings, which are arranged in reaction zones, and the membrane 20. The reaction zones are formed by a contact zone in each case of one of the electrodes 14, 16 and the membrane 20.

The membrane 20 is impregnated with an electrolyte formed from a solution of potassium hydroxide, and permits passage of hydroxide ions but prevents transfer from one reaction zone to the other reaction zone of atomic and molecular hydrogen and oxygen produced in the reaction zones, said hydrogen and oxygen arising in the reaction zones formed by the contact zone between the membrane 20 and electrode 14 and the contact zone between the membrane 20 and electrode 16. The electrodes 14, 16 are connected to a power source 52 and are connected to the power source 52 via the electrolyte in the membrane 20 in a closed circuit. The energy for electrolytic water splitting is introduced by the power source 52 via the circuit. Hydrogen in molecular form is produced on a side of the electrolytic cell 12 shown on the left in the drawings in the contact zone between the membrane 20 and electrode 14, by way of water being reduced in a redox reaction at the electrode 14, wherein by feeding electrons through the electrode 14 water molecules are converted into hydroxide ions and molecular hydrogen, and diffuses through the electrode 14 into a gas chamber 40, from where it passes via a gas pipe 42 into a gas tank 44 for storage. On a side of the electrolytic cell 12 shown on the right in the drawings in the contact zone between the membrane 20 and electrode 16, oxygen in molecular form is produced by oxidation, wherein hydroxide ions are oxidized into water and molecular oxygen with release of electrons at the electrode 16, and diffuses through the electrode 16 into a gas chamber 46, from where it is conveyed into a gas tank 50 via a gas pipe 48. The electrolytic cell 12 further comprises a heating unit 38 with a pipe through which heated water flows to heat the electrolytic cell 12 to an operating temperature of approx. 80 degrees.

In the method according to the invention for operating an electrolytic cell 12 for electrolytic water splitting having a membrane 20, the membrane 20 is supplied with liquid water in a passive manner. Herein, in one method step water is distributed within the membrane 20 by means of a channel structure 26 formed in the membrane 20 and in a simultaneous method step water is introduced, without a pump, into the membrane 20 by means of a capillary effect of a cavity structure of the at least one membrane 20 from a water reservoir with a capillary pressure of 50 mbar. The introduction of liquid water with a higher capillary pressure, for example of 100 mbar or 200 mbar, or with a lower capillary pressure, for example of 40 mbar, is also conceivable if the cavity structure 28 is suitably constructed, in particular by modifying a pore size. The membrane 20 is thus implemented as a passive water supply unit 30, which introduces water from a water feed unit 32 of the electrolytic system 10 into the membrane 20 and distributes it in the membrane 20. The water reservoir is formed of liquid water accommodated in the water feed unit 32. The passive water supply unit 30 comprises a channel structure 26 of the membrane 20 for large-area distribution of water within the membrane 20 and comprises a cavity structure 28 for taking up water by capillary effect with a pore size of 2 micrometers. The cavity structure 28 is implemented as a fine-pored pore structure. In principle, the cavity structure 28 may also have a different pore size, for example in the range of 0.2 micrometers to 10 micrometers. The stated pore size values should be understood to mean the average size of the pores in the cavity structure 28. A diameter of channels in the channel structure 26 of the membrane 20 amounts to one tenth of a millimeter, wherein different diameters, for example in a range between 10 micrometers and one millimeter, are in principle also possible.

The membrane 20 comprises a coarse-pored inner membrane region 22 with a pore size of 10 micrometers, in which the channel structure 26 is introduced (FIG. 2). The channels of the channel structure 26 extend over an entire longitudinal extent of the inner membrane region 22 and further comprise branching side channels, which bring about transverse distribution of the taken-up water. In principle, the channels of the channel structure 26 may also pass straight through the inner membrane region 22 and be configured without side channels. A line density of channels of the channel structure 26 preferably amounts for instance to 2/mm, at least 0.5/mm and at most 5/mm. The cavity structure 28 is introduced in a outer membrane region 24, which forms a fine-pored structure relative to the inner membrane region 22. The inner membrane region 22 and outer membrane region 24 are made from the same material, formed of a polysulfone, and differ merely in pore size. The membrane 20 with the inner membrane region 22 and the outer membrane region 24 is implemented as a flat membrane, wherein the outer membrane region 24 encloses the inner membrane region 22 on two sides and the outer membrane region 24 is in contact with the electrodes 14, 16, while the inner membrane region 22 has no contact with the electrodes 14, 16.

The water feed unit 32 comprises a water tank 36 and a water pipe 34 which guides liquid water to the membrane 20. The water tank 36 and the water pipe 34 have no pump. The membrane 20 is thus connected, without a pump, to the water feed unit 32. The liquid water in the water feed unit 32 flows into the coarse-pored inner membrane region 22 and into the channels of the channel structure 26 in the inner membrane region 22 and is taken up by a capillary effect of the cavity structure 28 of the outer membrane region 24 from the channel structure 26 and the water feed unit 32 and is conveyed into the outer membrane region 24 and the reaction zone for splitting. The channel structure 26 of the inner membrane region 22 distributes the water in the membrane 20. The cavity structure 28 and the channel structure 26 are matched with one another such that sufficient water is supplied to the membrane 20 even when the electrolytic cell 12 is at maximum operating capacity and water consumption is at its maximum. In the absence of the channel structure 26, the membrane 20 might be inadequately supplied with water, since the capillary effect introduces water into the membrane 20 with a capillary rise predetermined by pore size and the material of the membrane 20, and the water is subsequently further distributed within the membrane 20 by diffusion. Diffusion through fine pores of the cavity structure 28 has a low delivery capacity, such that a membrane 20 consisting solely of the outer membrane region 24 has insufficient water delivery capacity to form a passive water supply unit 30. Further distribution of the water by the channels of the channel structure 26 of the inner membrane region combined with the delivery capacity which is achieved by the cavity structure 28 of the outer membrane region 24, thus has the effect that the membrane 20 is implemented as a passive water supply unit 30. In the absence of the cavity structure 28 of the fine-pored outer membrane region 24, a membrane 20 would only take up a small quantity of water from the water reservoir in the water feed unit 32, due to the slight capillary effect, and the membrane 20 would therefore have insufficient water delivery capacity to form a passive water supply unit 30.

The membrane 20 is bonded to a cell frame 18 which forms a cell wall of the electrolytic cell 12. The cell frame 18 is formed from a temperature-resistant plastics material which is dimensionally stable at the operating temperature. A bonded connection between the membrane 20 and the cell frame 18 is achieved in a method step of a method for producing an electrolytic cell 12 according to the invention by adhesive bonding, wherein other joining methods such as hot pressing may in principle also be used. The bonded connection achieves sealing of the electrolytic cell 12 while dispensing with an additional sealing element.

As a person skilled in the art will readily realize, an electrolytic system 10 according to the invention is not limited to an individual electrolytic cell 12, but rather may comprise a plurality of electrolytic cells 12, which are connected, without a pump, to separate or common water feed units 32.

In a proposed method for producing a membrane 20 of an electrolytic cell 12 according to the invention, a channel structure 26 is milled mechanically into a first membrane sub-unit 54, which after production forms the coarse-pored inner membrane region 22. In a further method step, the first membrane sub-unit 54 is connected to a second membrane sub-unit 56, which completely envelops the first membrane sub-unit 54 and after production forms the outer membrane region 24 with the cavity structure 28.

FIG. 2 shows a portion of the electrolytic cell 12 of the electrolytic system 10 according to the invention with the membrane 20 and a portion of the water feed unit 32 in an enlarged representation.

### REFERENCE SIGNS

10 Electrolytic system
12 Electrolytic cell
14 Electrode
16 Electrode
18 Cell frame
20 Membrane
22 Inner membrane region
24 Outer membrane region
26 Channel structure
28 Cavity structure
30 Water supply unit
32 Water feed unit
34 Water pipe
36 Water tank
38 Heating unit
40 Gas chamber
42 Gas pipe
44 Gas tank
46 Gas chamber
48 Gas pipe
50 Gas tank
52 Power source
54 Membrane sub-unit
56 Membrane sub-unit

1. A method for operating an electrolytic cell for electrolytic water splitting, the electrolytic cell comprising:
at least one membrane, wherein
the at least one membrane is supplied with liquid water in a passive manner.

2. The method according to claim 1, wherein
in at least one method step, water is distributed within the membrane by means of a channel structure formed in the at least one membrane.

3. The method according to claim 1, wherein
in at least one method step, water is introduced into the membrane, without a pump, from a water reservoir by means of a capillary effect of at least one cavity structure of the at least one membrane.

4. The method according to claim 3, wherein
in the at least one method step, water is introduced into the membrane with a capillary pressure of at least 25 mbar.

5. An electrolytic system with at least one electrolytic cell for electrolytic water splitting, the electrolytic cell comprising at least one membrane, and with a water feed unit for supplying water to the electrolytic cell, wherein the at least one membrane is implemented as a passive water supply unit.

6. The electrolytic system according to claim 5, wherein the passive water feed unit comprises at least one channel structure for large-area distribution of water within the at least one membrane.

7. The electrolytic system according to claim 5, wherein the passive water feed unit comprises at least one cavity structure for uptake of water by means of the capillary effect.

8. The electrolytic cell according to claim 7, wherein the at least one cavity structure has a pore size of at most 10 micrometers.

9. The electrolytic system at least according to claim 6, wherein the at least one membrane is connected, without a pump, to the water feed unit.

10. The electrolytic system at least according to claim 5, wherein the at least one membrane is bonded to a cell frame.

11. An electrolytic cell for an electrolytic system according to claim 5.

12. A method for producing a membrane of an electrolytic cell according to claim 11, wherein a channel structure is milled mechanically into at least one first membrane sub-unit.

13. A method according to claim 12, wherein the at least one first membrane sub-unit is connected to at least one second membrane sub-unit which at least partially envelops the first membrane sub-unit.

14. The method according to claim 2, wherein
in at least one method step, water is introduced into the membrane, without a pump, from a water reservoir by means of a capillary effect of at least one cavity structure of the at least one membrane.

15. The method according to claim 14, wherein
in the at least one method step, water is introduced into the membrane with a capillary pressure of at least 25 mbar.

16. The electrolytic system according to claim 6, wherein the passive water feed unit comprises at least one cavity structure for uptake of water by means of the capillary effect.

17. The electrolytic cell according to claim 16, wherein the at least one cavity structure has a pore size of at most 10 micrometers.

18. An electrolytic cell for an electrolytic system according to claim 6.

19. An electrolytic cell for an electrolytic system according to claim 7.

20. An electrolytic cell for an electrolytic system according to claim 10.
